(19) United States
(12) Patent Application Publication
(10) Pub. No.: US 2004/0225025 A1
(43) Pub. Date: Nov. 11, 2004

(54) Curable compositions for display devices

(76) Inventors: Michael G. Sullivan, Belvidere, IL (US); Chander Prakash Chawla, Batavia, IL (US)

Correspondence Address: MAYER, BROWN, ROWE & MAW LLP, 1909 K STREET, N.W., WASHINGTON, DC, 20006, US

(21) Appl. No.: 10/768,697

(22) Filed: Feb. 2, 2004

Related U.S. Application Data
(63) Continuation of application No. PCT/NL02/00528, filed on Aug. 5, 2002.
(60) Provisional application No. 60/309,522, filed on Aug. 3, 2001.

(51) Int. Cl. C08F 2/46; C08G 59/00

(52) U.S. Cl. 522/71; 528/405; 528/407; 522/178

(57) ABSTRACT

Provided are curable compositions for the preparation of displays. The compositions are particularly suitable as adhesives, sealants, and/or encapsulants for displays. Compositions according to the invention include those having an epoxy resin and a hydroxy-functional compound, wherein the compositions provide good barrier properties after cure.

### FIELD OF THE INVENTION

The present invention relates to curable compositions for display devices, e.g. liquid crystal displays and organic light emitting diode displays. The present compositions are particularly suitable as adhesives, sealants, and/or encapsulants.

### BACKGROUND

A liquid crystal display (“LCD”) typically comprises a liquid crystal material that is housed between two sheets (e.g. glass sheets or plastic sheets). Adhesives find several applications in the field of LCD manufacturing. First, an adhesive is typically used to bond the above-mentioned two sheets together and the adhesive acts as a gasket or a sealant to confine liquid crystal material within the display. Generally, a small gap is left in the gasket. The gap is used to introduce the liquid crystal material into the display. After filling the display with liquid crystal material, the gap is sealed with adhesive. Adhesives are also used to bond electrode terminals to the display. Further details about liquid crystal displays and the use of adhesives in liquid crystal displays can be found in the article entitled “Ultraviolet curable adhesive applications on the liquid crystal display” by John M. Dooley, published on pages 13-16 in the December 1993 issue of “European Adhesives and Sealants”. Said pages 13-16 are hereby incorporated in their entirety by reference.

The production of LCD's often involves a high temperature silicon deposition. Furthermore, LCD's tend to heat up during use (e.g. because of light absorption by polarizers used in the LCD's). Accordingly, sealants and adhesives for LCD's should be resistant to elevated temperatures. Other requirements for adhesives/sealants include good adhesion to the LCD sheets and a low water vapor transmission (water can be detrimental to, for instance, the electrodes).

A low water vapor transmission (“WVT”) is particularly important in the field of organic light emitting diodes (“OLED”). Displays based on OLED's are believed to maintain several advantages over LCD's, for instance superior imaging capabilities and a longer battery life. However, OLED's often comprise comparatively unstable organic materials (e.g. comparatively unstable conjugated polymers) and highly water sensitive electrodes (e.g. calcium based electrodes). Accordingly, sealants for OLED's should have excellent barrier properties.

It is an object of the present invention to provide adhesives/sealants for displays, wherein the adhesives/sealants exhibit, after cure, a low water vapor transmission.

It is an object of the present invention to provide adhesives/sealants for displays, wherein the adhesives/sealants exhibit, after cure, good resistance to high temperatures.

Particularly, it is an object of the present invention to provide adhesives/sealants for displays wherein the adhesives/sealants exhibit, after cure, a combination of high temperature resistance, good adhesion, and a low water vapor transmission.

### SUMMARY OF THE INVENTION

The present invention provides curable compositions for the preparation of displays. The compositions are particularly suitable as adhesives, sealants, and/or encapsulants for displays. Compositions according to the invention include those having an epoxy resin and a hydroxy-functional compound, wherein the compositions provide good barrier properties after cure.

### DETAILED DESCRIPTION OF THE INVENTION

The present invention provides compositions for display devices (e.g. adhesives, sealants, and/or encapsulants for display devices), wherein the composition comprises:

(i) an epoxy resin; and,

(ii) a hydroxy-functional component.

(i) Epoxy Resin

The present compositions contain one or more epoxy resins. Preferably, the compositions will comprise at least one liquid (at room temperature, 23° C.) component such that the combination of materials is a liquid. Thus, the epoxides-containing material is preferably a single liquid epoxy material, a combination of liquid epoxy materials, or a combination of liquid epoxy material(s) and solid epoxy material(s) which is soluble in the liquid. However, in certain embodiments, e.g. in embodiments where the epoxide material is soluble in other components of the adhesive, the epoxide material may be comprised only of materials that are solid at room temperature.

Examples of suitable epoxy materials include polyglycidyl and poly(methylglycidyl) esters of polycarboxylic acids, or poly(oxiranyl) ethers of polyethers. The polycarboxylic acid can be aliphatic, such as, for example, glutaric acid, adipic acid and the like; cycloaliphatic, such as, for example, tetrahydrophthalic acid; or aromatic, such as, for example, phthalic acid, isophthalic acid, trimellitic acid, or pyromellitic acid. The polyether can be poly(tetramethylene oxide).

Suitable epoxy materials also include polyglycidyl or poly(-methylglycidyl) ethers obtainable by the reaction of a compound having at least one free alcoholic hydroxy group and/or phenolic hydroxy group and a suitably substituted epichlorohydrin. The alcohols can be acyclic alcohols, such as, for example, ethylene glycol, diethylene glycol, and higher poly(oxyethylene) glycols; cycloaliphatic, such as, for example, 1,3- or 1,4-dihydroxycyclohexane, bis(4-hydroxycyclohexyl)methane, 2,2-bis(4-hydroxycyclohexyl)propane, or 1,1-bis(hydroxymethyl)cyclohex-3-ene; or contain aromatic nuclei, such as N,N-bis(2-hydroxyethyl)aniline or p,p′-bis(2-hydroxyethylamino)diphenylmethane.

Other suitable epoxy compounds include those which may be derived from mono nuclear phenols, such as, for example, resorcinol or hydroquinone, or they may be based on polynuclear phenols, such as, for example, bis(4-hydroxyphenyl)methane (bisphenol F), 2,2-bis(4-hydroxyphenyl)propane (bisphenol A), or on condensation products, obtained under acidic conditions, of phenols or cresols with formaldehyde, such as phenol novolacs and cresol novolacs.

Particularly preferred epoxies include cycloaliphatic epoxies (e.g. cyclohexeneoxide epoxies), bisphenol epoxies (e.g. bisphenol A epoxies or bisphenol F epoxies), and novolac epoxies (e.g. cresolic novolac epoxies or phenolic novolac epoxies). Regarding cycloaliphatic epoxies, it is further preferred that the epoxy compounds comprise at least one cyclohexeneoxide structure, more preferably at least 2 cyclohexeneoxide structures.

Preferred cycloaliphatic diepoxides include bis(4hydroxycyclohexyl)methane diglycidyl ether, 2,2-bis(4-hydroxycyclohexyl)propane diglycidyl ether, 3,4-epoxycyclohexylmethyl-3,4-epoxycyclohexanecarboxylate, 3,4-epoxy-6methylcyclohexylmethyl-3,4-epoxy-6-methylcyclohexanecarboxylate, di(3,4-epoxycyclohexylmethyl)hexanedioate, di(3,4-epoxy-6-methylcyclohexylmethyl)hexanedioate, ethylenebis(3,4-epoxycyclohexanecarboxylate), ethanedioldi(3,4-epoxycyclohexylmethyl) ether, 2-(3,4-epoxycyclohexyl-5,5-spiro-3,4-epoxy)cyclohexane-1,3-dioxane, and combinations thereof.

The epoxy materials can have molecular weights which vary over a wide range. Generally, the epoxy equivalent weight, ie. the number average molecular weight divided by the number of reactive epoxy groups, is in the range of 60 to 1000.

Preferably the compositions of the present invention comprise, relative to the total weight of the composition, at least 10 wt %, more preferably at least 20 wt %, and most preferably at least 30 wt % of cationically curable components. Preferably the compositions of the invention comprise, relative to the total weight of the composition, less than 90 wt %, more preferably less than 80wt %, and most preferably less than 70 wt % of cationically curable components.

(ii) Hydroxy-functional Component

The present compositions comprise an hydroxy-functional component. The hydroxy-functional component which can be used in the present invention may be any suitable organic material having a hydroxyl functionality of at least 1, more preferably at least 2, and most preferably at least 3. Preferably the hydroxyl-containing material is aliphatic. Materials comprising more than one hydroxyl group are also referred to as polyols. Materials comprising one hydroxyl group are also referred to as monols.

Any hydroxy group may be employed for the particular purpose. Preferably the hydroxyl-containing material contains two or more primary or secondary aliphatic hydroxyl. The hydroxyl group may be internal in the molecule or terminal. Monomers, oligomers or polymers can be used. The hydroxyl equivalent weight, i.e., the number average molecular weight divided by the number of hydroxyl groups, is preferably in the range of 31 to 5000.

Representative examples of hydroxyl-containing materials having a hydroxyl functionality of 1 include alkanols, monoallcyl ethers of polyoxyalkyleneglycols, monoalkyl ethers f alkyleneglycols, and others, and combinations thereof.

Representative examples of useful monomeric polyhydroxy organic materials include alkylene and arylalkylene glycols and polyols, such as 1,2,4-butanetriol, 1,2,6-hexanetriol, 1,2,3-heptanetriol, 2,6-dimethyl-1,2,6-hexanetriol, (2R,3R)-(-)-2-benzyloxy-1,3,4-butanetriol, 1,2,3-hexanetriol, 1,2,3-butanetriol, 3-methyl-1,3,5-pentanetriol, 1,2,3-cyclohexanetriol, 1,3,5-cyclohexanetriol, 3,7,11,15-tetramethyl-1,2,3-hexadecanetriol, 2-hydroxymethyltetrahydropyran-3,4,5-triol, 2,2,4,4-tetramethyl-1,3-cyclobutanediol, 1,3-cyclopentanediol, trans-1,2-cyclooctanediol, 1,16-hexadecanediol, 3,6-dithia-1,8-octanediol, 2-butyne-1,4-diol, 1,3-propanediol, 1,4-butanediol, 1,5-pentanediol, 1,6-hexanediol,1,7-heptanediol, 1,8-octanediol, 1,9-nonanediol, 1-phenyl-1,2-ethanediol, 1,2-cyclohexanediol, 1,5-decalindiol, 2,5-dimethyl-3-hexyne-2,5-diol, 2,7-dimethyl-3,5-octadiyne-2-7diol, 2,3-butanediol, 1,4-cyclohexanedimethanol, and combinations thereof.

Representative examples of useful oligomeric and polymeric hydroxyl-containing materials include polyoxyethylene and polyoxypropylene glycols and triols of molecular weights from about 200 to about 10,000; polytetramethylene glycols of varying molecular weight; poly(oxyethylene-oxybutylene) random or block copolymers; copolymers containing pendant hydroxy groups formed by hydrolysis or partial hydrolysis of vinyl acetate copolymers, polyvinylacetal resins containing pendant hydroxyl groups; hydroxy-terminated polyesters and hydroxy-terminated polylactones; hydroxy-functionalized polyalkadienes, such as polybutadiene; aliphatic polycarbonate polyols, such as an aliphatic polycarbonate diol; and hydroxy-terminated polyethers, and combinations thereof.

Preferred hydroxyl-containing monomers include 1,4-cyclohexanedimethanol and aliphatic and cycloaliphatic monohydroxy alkanols. Preferred hydroxyl-containing oligomers and polymers include hydroxyl and hydroxyl/epoxy functionalized polybutadiene, polycaprolactone diols and triols, ethylene/butylene polyols, and monohydroxyl functional monomers. Preferred examples of polyether polyols are polypropylene glycols of various molecular weights and glycerol propoxylate-B-ethoxylate triol. Also preferred are linear and branched polytetrahydrofuran polyether polyols available in various molecular weights, such as in the range of 150-4000 g/mol, preferably in the range of 150-1500 g/mol, more preferably in the range of 150-750 g/mol.

Especially preferred polyols include (i) polyester polyols, (ii) polyols comprising one or more caprolactone residues, and (iii) C₁-C₁₀ glycols (e.g. ethylene glycol, propylene glycol, or butylene glycol). Particularly preferred are polyester polyols comprising caprolactone residues, such as the trimethylolpropane triester with caprolactone.

In one embodiment, the compositions preferably comprise, relative to the total weight of the composition, at least 1 wt % of one or more hydroxy-functional compounds. In another embodiment, the compositions preferably comprise, relative to the total weigh of the composition, at least 5 wt %, and most preferably at least 10 wt % of one or more hydroxy-functional compounds. Furthermore, the compositions preferably comprise, relative to the total weight of the composition, at most 60 wt % of one or more hydroxy-functional compounds, more preferably at most 40 wt %, and most preferably at most 25wt %. C₁-C₁₀ glycols are preferably present in an amount of at most 10 wt %, more preferably at most 5 wt % relative to the total weight of the composition.

Preferably the ratio of the number of epoxide equivalents to the number of hydroxyl equivalents in the present compositions (hereinafter also referred to as “EH ratio” or “EHR”) is at least 1.5, more preferably at least 1.65, most preferably at least 1.8. If the EH ratio is below 1.5, the resistance of the composition to yellowing and/or degradation may decrease. The EH ratio is preferably below 100, more preferably below 20, even more preferably below 5, and most preferably about 2.

In one embodiment, the ratio of the combined weight of epoxy-functional components and hydroxy-functional components in the composition to the number of hydroxyl groups in the composition (hereinafter also referred to as “Weight Per Hydroxy” or “WPH”) is at least 350. In another embodiment, the WPH is at least 400, and in an even further embodiment the WPH is at least 500. Increased WPH values may increase the flexibility of the compositions (when cured).

Preferably the combined weight of epoxy resins and hydroxy-functional components makes up, relative to the total weight of the composition, at least 70 wt % of the composition, more preferably at least 80 wt %, even more preferably at least 90 wt %, and most preferably at least 95 wt %.

(iii) Adhesion Promoter

The present compositions preferably comprise a suitable adhesion promoter or mixture of adhesion promoters. Suitable adhesion promoters include silane adhesion promoters. Examples of silane adhesion promoters include acrylate-functional silanes; amino-functional silanes; mercapto-functional silanes; methacrylate-functional silanes; acrylamido-functional silanes; allyl-functional silanes; epoxy-functional silanes; and vinyl-functional silanes. The adhesion promoters preferably are methoxy- or ethoxy-substituted as well. Preferably the present adhesives comprise an epoxy-functional silane adhesion promoter, more preferably an epoxy-functional trialkoxy silane adhesion promoter, most preferably a 3-glycidoxypropyltrimethoxysilane adhesion promoter. Commercial examples of a 3-glycidoxypropyltrimethoxysilane adhesion promoter include Z-6040 from Dow Corning.

The present compositions preferably comprise, relative to the total weight of the composition, 0.1-10 wt % of adhesion promoter, more preferably 0.1-5 wt %, most preferably 0.25-3 wt%.

(iv) Cationic Photoinitiator

The present compositions preferably comprise a cationic photoinitiator. In the compositions according to the invention, any suitable type of photoinitiator that, upon exposure to actinic radiation, forms cations that initiate the reactions of the cationically polymerizable compounds, such as epoxy material(s), can be used. There are a large number of known and technically proven cationic photoinitiators that are suitable. They include, for example, onium salts with anions of weak nucleophilicity. Examples are halonium salts, iodosyl salts or sulfonium salts, such as are described in published European patent application EP 153904 and WO 98/28663, sulfoxonium salts, such as described, for example, in published European patent applications EP 35969, 44274, 54509, and 164314, or diazonium salts, such as described, for example, in U.S. Pat. Nos. 3,708,296 and 5,002,856. All eight of these disclosures are hereby incorporated in their entirety by reference. Other cationic photoinitiators are metallocene salts, such as described, for example, in published European applications EP 94914 and 94915, which applications are both hereby incorporated in their entirety by reference.

A survey of other current onium salt initiators and/or metallocene salts can be found in “UV Curing, Science and Technology”, (Editor S. P. Pappas, Technology Marketing Corp., 642 Westover Road, Stamford, Conn., U.S.A.) or “Chemistry & Technology of UV & EB Formulation for Coatings, Inks & Paints”, Vol. 3 (edited by P. K. T. Oldring), and both books are hereby incorporated in their entirety by reference.

Preferred initiators include diaryl iodonium salts, triaryl sulfonium salts, or the like. Typical photo-polymerization initiators are represented by the following formulae (1) and (2):

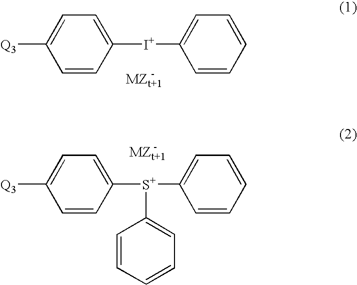

wherein

Q₃ represents a hydrogen atom, an alkyl group having 1 to 18 carbon atoms, or an alkoxyl group having 1 to 18 carbon atoms;

M represents a metal atom, for instance antimony;

Z represents a halogen atom, for instance fluorine; and

t is the valent number of the metal, for example 6 in the case of antimony.

Preferably, the present compositions comprise, relative to the total weight of the adhesive, 0.1-15 wt % of one or more cationic photoinitiators, more preferably 1-10 wt %.

(v) Antioxidant

The present compositions preferably comprise an antioxidant. Any suitable antioxidant may be used. Preferred antioxidants include hindered phenol antioxidants, for instance octadecyl-3-(3′,5′-di-tert-butyl-4′- hydroxyphenyl) propionate, thiodiethylene bis (3,5di-tert-butyl-4-hydroxy) hydrocinnamate, butylated paracresol-dicyclopentadiene copolymer; and tetrakis [methylene (3,5di-tert-butyl-4-hydroxyhydro-cinnamate)] methane. Commercial examples include Irganox 1010 and Irganox 1035 from Ciba Geigy. Preferably the present compositions comprise, relative to the total weight of the composition, 0.1-5 wt % of antioxidant, more preferably 0.1-2 wt %.

(vi) Free Radically Polymerizable Components, and

(vii) Free Radical Photoinitiators

The present compositions may comprise free radically polymerizable components, for instance allyl-, acrylate- or methacrylate functional components, and free radical photoinitiators, for instance acetophenone or benzil ketal free radical photoinitiators. However, their presence is generally not preferred, for instance because their presence tends to result in cured compositions having a comparatively low high temperature resistance to yellowing. Preferably the present compositions comprise, relative to the total weight of the composition, less than 30 wt % of free radical polymerizable components, more preferably less than 15 wt %, even more preferably less than 5 wt %, and most preferably the present compositions are absent free radical polymerizable components. The present compositions preferably comprise, relative to the total weight of the composition, less than 2 wt % of free radical photoinitiators, more preferably less than 1 wt %, and most preferably the present compositions are absent free radical photoinitiators.

(viii) Additives

The present compositions may further comprise any suitable additive. Examples of additives include, for instance, inert inorganic materials (e.g. silicon dioxides or nanoclays), surfactants, and the like. Silicon dioxides and nanoclays may aid in further improving the barrier properties of the present composition, for instance further reducing the water vapor transmission and/or permeance of the cured composition. If present, silicon dioxides and nanoclays are preferably used in amounts of 0.1-10 wt %, more preferably 0.1-5 wt %, and most preferably 0.1-3 wt % relative to the total weight of the composition.

Applications

The present compositions are suitable in the preparation of displays, e.g. as adhesives, sealants (for instance side sealants), and/or encapsulants for displays.

For instance, the present compositions are suitable in the fabrication of LCD's. LCD's generally comprise a liquid crystal material that is housed between two sheets, for instance glass sheets or plastic sheets. The present compositions may be used to bond the two sheets together, and the compositions may act as a gasket or a (side) sealant to confine liquid crystal material within the display. Generally, a small gap is left in the gasket. The gap is used to introduce the liquid crystal material into the display. After filling the display with liquid crystal material, the present compositions may be used to seal the gap. The present compositions may also be used to bond electrode terminals to the display.

Further examples of displays in which the present compositions may be used include organic light emitting diode (OLED) displays. The present compositions are particularly suitable as encapsulants or (side-) sealants for OLED's to protect the organic light emitting layer and/or the electrodes in the OLED's from oxygen and, particularly, water.

Accordingly, preferred compositions include those that provide good adhesion to substrates and good barrier properties. Also, because the production of LCD's often involves a high temperature silicon deposition step, it is preferred that the compositions for displays have good high temperature resistance. Furthermore, in particular from an integrity and aesthetic point of view, it is preferred that the compositions provide good scratch resistance. Consequently, preferred compositions according to the present invention include those having (when cured) one or more of the following properties:

(i) a water vapor transmission, as measured according to the test method set forth herein, of less than 10 g/hr·m², preferably less than 5 g/hr·m², more preferably less than 1.5 g/hr·m², and most preferably less than 0.5 g/hr·m²;

(ii) a water vapor permeance, as measured according to the test method set forth herein, of less than 0.06 g/Pa·hr·m², preferably less than 0.03 g/Pa·hr·m², more preferably less than 0.01 g/Pa·hr·m², and most preferably less than 0.001 g/Pa·hr·m2;

(iii) an adhesion to glass, as determined at 50% humidity and 23° C. by a 180° peel test at a peeling rate of 0.1 inch/min, of at least 20 g/in and below 1000 g/in, more preferably at least 40 g/in, and most preferably at least 60 g/in;

(iv) a hardness of at least H, more preferably at least 3H, and most preferably at least 6H.

A process for preparing a display according to the present invention includes curing the present composition. The curing may be effected by any suitable means, preferably by radiation (e.g. electron beam radiation or, preferably, UV radiation) and/or heat. Preferably the process includes curing the adhesive by UV radiation.

The present displays may be used in a wide variety of articles, for instance in computers (e.g. in computer monitor screens or laptop screens), televisions, cameras (e.g. camcorders), watches, calculators, cell phones, telephones, pagers, palm pilots, stereos (e.g. in car stereo displays) etc.

### EXAMPLES

The following examples are given as particular embodiments of the invention and to demonstrate the practice and advantages thereof. It is to be understood that the examples are given by way of illustration and are not intended to limit the specification or the claims that follow in any manner.

### Examples 1-21

Compositions were prepared, cured, and tested. The composition formulations and test results are set forth in the following Tables 1-4 (for details on sample preparation and test methods, please see the “Test Method” section below). All weight percentages in Tables 1-4 are relative to the total weight of the composition. Details about the ingredients used in the compositions are set forth in the following glossary:

Glossary

| Name | Description |
|---|---|
| Araldite GY 282 | Bisphenol F Epoxy available from Ciba Resins |
| CN 816 | Acrylic oligomer available from Sartomer |
| CN 817 | Acrylic oligomer available from Sartomer |
| CN 818 | Acrylic oligomer available from Sartomer |
| DEN 438 | Phenolic epoxy novolac resin available from Dow Chemical |
| Ebecryl 745 | Acrylic oligomer available from UCB Chemicals |
| Ebecryl 754 | Acrylic oligomer available from UCB Chemicals |
| Ebecryl 767 | Acrylic oligomer available from UCB Chemicals |
| Irgacure 1173 | Free radical photoinitiator available from Ciba Geigy |
| Irganox 1010 | Antioxidant available from Ciba Geigy |
| Irganox 1035 | Antioxidant available from Ciba Geigy |
| SR1010 | cationic photoinitiator: Triarylsulfonium hexafluoroantimonate (50% in |
| | propylene carbonate) available from Sartomer |
| SR1011 | cationic photoinitiator: Triarylsulfonium hexafluorophosphate (50% in propylene |
| | carbonate) from Sartomer |
| Surfynol 420 | ethoxylated acetylenic diols (>65% ethoxylated 2,4,7,9-tetramethyl-5-decyn-4,7- |
| | diol) available from Air Products |
| Uvacure 1500 | 3,4-epoxycyclohexyl-methyl-3,4-epoxycyclohexane carboxylate available from |
| | UCB Chemicals |
| Uvacure 1501 | Cycloaliphatic diepoxide available from UCB Chemicals |
| Uvacure 1502 | Cycloaliphatic diepoxide available from UCB Chemicals |
| Uvacure 1530 | mixture of aliphatic polyol and 3,4-epoxycyclohexyl-methyl-3,4- |
| | epoxycyclohexane carboxylate (EHR = 2, WPH = 370), available from UCB |
| | Chemicals. |
| Uvacure 1531 | mixture of aliphatic polyol and 3,4-epoxycyclohexyl-methyl-3,4- |
| | epoxycyclohexane carboxylate (EHR = 2, WPH = 446), available from UCB |
| | Chemicals. |
| Uvacure 1532 | mixture of aliphatic polyol and 3,4-epoxycyclohexyl-methyl-3,4- |
| | epoxycyclohexane carboxylate (EHR = 2, WPH = 555), available from UCB |
| | Chemicals. |
| Uvacure 1533 | modified cycloaliphatic epoxide available from UCB Chemicals. |
| Uvacure 1534 | mixture of aliphatic polyol and modified cycloaliphatic epoxy (EHR = 1.4, WPH = 375), |
| | available from UCB Chemicals. |
| UVI 6974 | mixture of triarylsulfonium hexafluoroantimonate salts, available from Union |
| | Carbide |
| UVI 6990 | mixture of triarylsulfonium hexafluorophosphate salts, available from Union |
| | Carbide |
| Z-6040 | 3-glycidoxypropyltrimethoxy silane, available from Dow Corning |
| Zeothix 177 | silicon dioxide, available from J.M. Huber Corporation |

TABLE 1

| | Ex. 1 | Ex. 2 |
|---|---|---|
| Ingredients | | |
| Araldite GY282 (epoxy), wt % | 45.0 | 46.0 |
| DEN 438 (epoxy), wt % | 51.0 | 48.0 |
| UVI 6974 (cationic photoinitiator), wt % | 2.0 | 2.0 |
| Ethylene Glycol (polyol), wt % | 2.0 | 2.0 |
| Zeothix 177 (silicon dioxide), wt % | — | 2.0 |
| Properties | | |
| Viscosity (cps) | 32,570 | 32,560 |
| Water Vapor Transmission | 0.20 | 0.10 |
| (g/hr · m²) | | |
| Water Vapor Permeance | 0.0015 | 0.00075 |
| (g/Pa · hr · m²) | | |

TABLE 2

| | Ex. 3 | Ex. 4 | Ex. 5 | Ex. 6 |
|---|---|---|---|---|
| Ingredient | | | | |
| Uvacure 1531 (epoxy/polyol mixture), wt % | 97.0 | 97.0 | — | — |
| Uvacure 1532 (epoxy/polyol mixture), wt % | — | — | 97.0 | — |
| Uvacure 1530 (epoxy/polyol mixture), wt % | — | — | — | 96.5 |
| Irganox 1010 (antioxidant), wt % | 0.5 | — | — | — |
| Irganox 1035 (antioxidant), wt % | — | 0.5 | 0.5 | 0.5 |
| SR1010 (cationic photoinitiator), wt % | — | 2.0 | — | 2.0 |
| SR1011 (cationic photoinitiator), wt % | 2.0 | — | 2.0 | — |
| Z-6040 (adhesion promoter), wt % | 0.5 | 0.5 | 0.5 | 1.0 |
| Properties | | | | |
| Water Vapor Transmission (g/hr · m²) | 2.7 | 2.1 | 4.1 | 1.1 |
| Water Vapor Permeance (g/Pa · hr · m²) | 0.020 | 0.016 | 0.030 | 0.008 |
| Adhesion to Glass and Mylar | excellent | excellent | excellent | excellent |

TABLE 3

| | Ex. 7 | Ex. 8 | Ex. 9 | Ex. 10 | Ex. 11 | Ex. 12 | Ex. 13 |
|---|---|---|---|---|---|---|---|
| Ingredient | | | | | | | |
| Ebecryl 745, wt % (acrylic | 97 | — | — | — | — | — | — |
| oligomer) | | | | | | | |
| Ebecryl 754, wt % (acrylic | — | 97 | — | — | — | — | — |
| oligomer) | | | | | | | |
| Ebecryl 767, wt % (acrylic | — | — | 97 | — | — | — | — |
| oligomer) | | | | | | | |
| CN 816, wt % (acrylic | — | — | — | 97 | — | — | — |
| oligomer) | | | | | | | |
| CN 817, wt % (acrylic | — | — | — | — | 97 | — | — |
| oligomer) | | | | | | | |
| CN 818, wt % (acrylic | — | — | — | — | — | 97 | — |
| oligomer) | | | | | | | |
| Araldite GY282 (epoxy), wt % | — | — | — | — | — | — | 63 |
| DEN 438 (epoxy), wt % | — | — | — | — | — | — | 35 |
| Surfynol 420, wt % | — | — | — | — | — | — | 1.0 |
| UVI 6974 (cationic | — | — | — | — | — | — | 1.0 |
| photoinitiator), wt % | | | | | | | |
| Irgacure 1173, wt % (free | 3 | 3 | 3 | 3 | 3 | 3 | — |
| radical photoinitiator) | | | | | | | |
| Properties | | | | | | | |
| Yellowing rating after 8 hrs @ | 3 | 3 | 3 | 4 | 4 | 4 | 1 |
| 300° C. | | | | | | | |
| Yellowing rating after 8 hrs @ | 3 | 3 | 3 | 4 | 4 | 4 | 1 |
| 250° C. | | | | | | | |

TABLE 4

| | Ex. 14 | Ex. 15 | Ex. 16 | Ex. 17 | Ex. 18 | Ex. 19 | Ex. 20 | Ex. 21 |
|---|---|---|---|---|---|---|---|---|
| Ingredient | | | | | | | | |
| Uvacure 1500 (epoxy) | 97 | — | — | — | — | — | — | — |
| Uvacure 1501 (epoxy) | — | 97 | — | — | — | — | — | — |
| Uvacure 1502 (epoxy) | — | — | 97 | — | — | — | — | — |
| Uvacure 1530 (epoxy/polyol | — | — | — | 97 | — | — | — | — |
| mixture, EHR = 2), wt % | | | | | | | | |
| Uvacure 1531 (epoxy/polyol | — | — | — | — | 97 | — | — | — |
| mixture, EHR = 2), wt % | | | | | | | | |
| Uvacure 1532 (epoxy/polyol | — | — | — | — | — | 97 | — | — |
| mixture, EHR = 2), wt % | | | | | | | | |
| Uvacure 1533 (epoxy) | — | — | — | — | — | — | 97 | — |
| Uvacure 1534 (epoxy/polyol | — | — | — | — | — | — | — | 97 |
| mixture, EHR = 1.4), wt % | | | | | | | | |
| UVI 6990 (cationic | 3 | 3 | 3 | 3 | 3 | 3 | 3 | 3 |
| photoinitiator) | | | | | | | | |
| Properties | | | | | | | | |
| Yellowing rating after 8 hrs | 3 | 3 | 3 | 2 | 2 | 2 | 4 | 4 |
| @ 300° C. | | | | | | | | |
| Yellowing rating after 8 hrs | 2 | 2 | 2 | 1 | 1 | 2 | 4 | 4 |
| @ 250° C. | | | | | | | | |

* The product obtained by curing the formulation of example 19 was more flexible than the product obtained by curing the formulation of example 18, which in turn was more flexible than the product obtained by curing the formulation of example 17 and the product obtained by curing the formulation of example 13.

### Test Methods

(i) Water Vapor Transmission (WVT) and Water Vapor Permeance (WVP).

For each composition in Table 1 and Table 2, the following procedure was followed: A 3 mil drawdown of the composition was cast on a 9×12 inch glass plate and fully cured with UV radiation to prepare a film of cured composition. A test dish (Payne cup, 3 inch diameter, ¾ inch depth) was filled with a ½ inch thick layer of desiccant (anhydrous calcium chloride, particle size 0.6-2.36 mm). The opening of the test dish was then covered with part of the film of cured composition, and the film was secured on the test dish with a sealing ring. In addition, the outer edges of the film were tightly wrapped with Parafilm™ (paraffinic film). The thus assembled test dish was weighed and then immediately placed in controlled environment (95% R.H. environment, 23° C.). At one hour intervals for a total period of 6 hours, the test dish was removed from the controlled environment, weighed, gently shaken (to mix the desiccant particles) and immediately replaced in the controlled environment. After these 6 hours, the test dish was placed in the controlled environment for an additional 18 hours, after which the test dish was once more weighed.

The datapoints were plotted in a graph, with the horizontal axis being time in hours and the vertical axis being the weight change (i.e. determined weight minus weight right before initial placement in the controlled environment). A curve was inscribed through the data points, which curve tended to become an upward straight line. The slope of this straight line was determined (in g/hr). The water vapor transmission was then calculated by multiplying the test area (i.e. the test dish opening area in m²) by this slope. The water vapor permeance was then calculated by dividing the water vapor transmission by 133.3 Pa (i.e. the vapor pressure difference). See also ASTM Method E 96-80, which is hereby incorporated in its entirety by reference.

(ii) Yellowing

For each composition in Table 3 and Table 4, the following procedure was followed: A first sample was prepared by covering a glass slide with a 5 micron thick layer of the composition. Subsequently, the composition was cured by UV radiation. A second sample was prepared in an identical manner as the first sample. One of the samples was then placed in an oven at 250° C. (air atmosphere), whereas the other sample was placed in an oven at 300° C. (air atmosphere). 8 hours after being placed in the oven, the samples were removed and visually (naked eye) graded for yellowing and burns. The following scale was used to grade the samples:

| Grade | Description |
|---|---|
| 1 | Clear, very little yellowing or very little |
| | burn black |
| 2 | Clear, very little yellowing, and slight |
| | peripheral burn black |
| 3 | Yellowing and peripheral burn black |
| 4 | Peripheral and internal burn black |

A composition having a rating of 1 or 2 after exposure for 8 hrs to 300° C. is considered to have a substantial resistance to yellowing.

Having described specific embodiments of the present invention, it will be understood that many modifications thereof will readily be apparent to those skilled in the art, and it is intended therefore that this invention is limited only by the spirit and scope of the following claims.

1. A curable composition for displays, said composition comprising:
(i) an epoxy resin; and
(ii) a hydroxy-functional compound;
wherein said composition has substantial resistance to yellowing.

2. A curable composition for displays, said composition comprising:
(i) an epoxy resin; and
(ii) a hydroxy-functional compound;
wherein said composition has a ratio of epoxy equivalents to hydroxy equivalents of at least 1.5

3. A curable composition for displays, said composition comprising:
(i) an epoxy resin;
(ii) a hydroxy-functional compound; and
(iii) 0-30 wt % of free radically polymerizable components.

4. A curable composition for displays, said composition comprising:
(i) an epoxy resin;
(ii) a hydroxy-functional compound; and
(iii) at least one compound selected from the group consisting of nanoclays and silicon dioxide.

5. The composition of claim 2, wherein said composition is an adhesive, sealant, and/or encapsulant for displays.

6. The composition of claim 2, wherein said epoxy resin is selected from the group consisting of cycloaliphatic epoxy resins, epoxy novolacs, and epoxy bisphenols.

7. The composition of claim 2, wherein said epoxy resin comprises at least two cyclohexene oxide structures.

8. The composition of claim 2, wherein said hydroxy-functional compound is a polyol.

9. The composition of claim 2, wherein said hydroxy-functional component is selected from the group consisting of polyester polyols, polyols comprising one or more caprolactone residues, and C₁-C₁₀ glycols.

10. The composition of claim 2, wherein said epoxy resin and said polyol make up, relative to the total weight of said composition, at least 70 wt % of said composition.

11. The composition of claim 2, wherein said epoxy resin and said polyol make up, relative to the total weight of said adhesive, at least 90 wt % of the adhesive.

12. The composition of claim 2, wherein said composition has a ratio of epoxy equivalents to hydroxy equivalents of at least 1.8.

13. The composition of claim 2, wherein said composition further comprises a silane adhesion promoter.

14. The composition according to claim 13, wherein said adhesion promoter is an epoxy-functional silane adhesion promoter.

15. The composition according to claim 13, wherein said adhesion promoter is a 3-glycidoxypropyltrimethoxysilane adhesion promoter.

16. The composition of claim 2, wherein said composition comprises, relative to the total weight of said composition, 0-5 wt % of free radically polymerizable components.

17. The composition of claim 2, wherein said composition is absent free radically polymerizable components.

18. The composition of claim 2, wherein said composition comprises, relative to the total weight of said composition, 0-5 wt % of components selected from the group consisting of acrylate-functional components, methacrylate-functional components, and allyl-functional components.

19. The composition of claim 2, wherein said composition is absent a free radical photointiator.

20. The composition of claim 2, wherein said composition comprises a cationic photoinitiator.

21. The composition of claim 2, wherein said composition comprises an antioxidant.

22. The composition of claim 2, wherein said composition comprises silicon dioxide.

23. The composition of claim 2, wherein said composition comprises a nanoclay.

24. A composition for displays, said composition consisting essentially of:
(i) one or more epoxy resins;
(ii) one or more hydroxyfunctional components;
(iii) one or more adhesion promoters;
(iv) one or more cationic photoinitiators;
(v) one or more antioxidants; and
(vi) optionally one or more components selected from the group consisting of silicon dioxide and nanoclays.

25. The composition of claim 24, wherein said one or more epoxy resins includes an epoxy resin selected from the group consisting of cycloaliphatic epoxy resins, epoxy novolacs, and epoxy bisphenols.

26. The composition of claim 24, wherein said one or more hydroxyfunctional components consist essentially of one or more polyols.

27. The composition of claim 24, wherein said one or more adhesion promoters include an epoxy-functional silane adhesion promoter.

28. The composition of claim 2, wherein said composition, after cure, has a water vapor transmission of less than 10 g/hr·m².

29. The composition of claim 2, wherein said composition, after cure, has a water vapor transmission of less than 1.5 g/hr·m².

30. The composition of claim 2, wherein said composition, after cure, has a water vapor permeance of less than 0.06 g/Pa·hr·m².

31. The composition of claim 2, wherein said composition, after cure, has a water vapor permeance of less than 0.01 g/Pa·hr·m².

32. The composition of claim 21, wherein said composition, after cure, has an adhesion to glass of at least 20 g/in.

33. The composition of claim 2, wherein said composition, after cure, has a hardness of at least H.

34. A curable composition for displays, said composition having substantial resistance to yellowing and, after cure, the following combination of properties:
(a) a water vapor transmission of less than 5 g/hr·m²;
(b) water vapor permeance of less than 0.01 g/Pa·hr·m²;
(c) an adhesion to glass of at least 40 g/in; and
(d) a hardness of at least H.

35. A process for preparing a display, said process comprising curing the composition of claim 2.

36. A liquid crystal display prepared by the process of claim 35.

37. An organic light emitting diode display prepared by the process of claim 35.

38. A computer, television, camera, watch, calculator, cell phone, telephone, pager, palm pilot, or stereo comprising a display prepared by the process of claim 35.
